(19) United States
(12) Patent Application Publication
(10) Pub. No.: US 2024/0305135 A1
(43) Pub. Date: Sep. 12, 2024

(54) POWER RECEIVING CIRCUIT AND BATTERY PACK

(71) Applicant: MURATA MANUFACTURING CO., LTD., Kyoto (JP)

(72) Inventor: Mikio YAMAMOTO, Kyoto (JP)

(21) Appl. No.: 18/543,105

(22) Filed: Dec. 18, 2023

(30) Foreign Application Priority Data
Mar. 6, 2023 (JP) 2023-033497

(51) Int. Cl. H02J 50/12; H02J 7/00

(52) U.S. Cl. CPC H02J 50/12; H02J 7/0029; H02J 2207/20

(57) ABSTRACT

A power receiving circuit according to an embodiment of the present disclosure includes: a power receiving antenna capable of receiving AC power supplied from a power feeding antenna by a magnetic field resonance method; a capacitor portion that is connected to the power receiving antenna, includes a first capacitor whose capacitance is changeable with temperature, and constitutes a resonance circuit together with the power receiving antenna; a conversion circuit capable of converting the AC power into DC power; and a heat conducting member capable of conducting heat from the conversion circuit to the first capacitor.

### CROSS REFERENCE TO RELATED APPLICATIONS

The present application claims priority to Japanese patent application no. 2023-033497, filed on Mar. 6, 2023, which is incorporated by reference herein.

### BACKGROUND

The present disclosure relates to a power receiving circuit that receives wirelessly supplied power, and a battery pack including such a power receiving circuit.

Some power feeding systems can wirelessly supply power. For example, a wireless power feeding system is disclosed and including a power feeding device and a power receiving device. In this system, the power receiving device transmits information instructing power to be transmitted to the power feeding device.

### SUMMARY

In an electronic device, it is generally desired to suppress heat generation, and it is also expected to effectively suppress heat generation in a power receiving circuit.

It is desirable to provide a power receiving circuit and a battery pack capable of effectively suppressing heat generation.

A power receiving circuit according to an embodiment of the present disclosure includes a power receiving antenna, a capacitor portion, a conversion circuit, and a heat conducting member. The power receiving antenna is capable of receiving AC power supplied from a power feeding antenna by a magnetic field resonance method. The capacitor portion is connected to the power receiving antenna, includes a first capacitor whose capacitance is changeable with temperature, and constitutes a resonance circuit together with the power receiving antenna. The conversion circuit is capable of converting the AC power into DC power. The heat conducting member is capable of conducting heat from the conversion circuit to the first capacitor.

A battery pack according to an embodiment of the present disclosure includes the power receiving circuit, a secondary battery, and a charging circuit. The charging circuit is capable of charging the secondary battery based on the DC power supplied from the conversion circuit of the power receiving circuit.

According to the power receiving circuit and the battery pack according to an embodiment of the present disclosure, heat generation can be effectively suppressed.

### BRIEF DESCRIPTION OF THE FIGURES

FIG. 1 is a block diagram illustrating a configuration example of a power feeding system according to an embodiment of the present disclosure;

FIG. 2 is an explanatory graph illustrating an example of characteristics of a resonance circuit;

FIG. 3 is an explanatory diagram illustrating an operation example of wireless power supply by a magnetic field resonance method;

FIG. 4 is an explanatory graph illustrating an example of characteristics of a capacitor in the resonance circuit of the battery pack illustrated in FIG. 1;

FIG. 5 includes views A and B and which is a circuit diagram illustrating a configuration example of a capacitor;

FIG. 6 includes views A to C which are explanatory graphs illustrating an example of characteristics of a capacitor;

FIG. 7 is a circuit diagram illustrating a configuration example of the conversion circuit illustrated in FIG. 1;

FIG. 8 includes views A and B and which is a timing chart illustrating an operation example of the charging circuit illustrated in FIG. 1;

FIG. 9A is a perspective view illustrating an example of an external configuration of the battery pack illustrated in FIG. 1;

FIG. 9B is a perspective view illustrating an example of an external configuration of the battery pack illustrated in FIG. 1;

FIG. 10 includes views A and B and which is an explanatory graph illustrating an operation example of the power feeding system illustrated in FIG. 1;

FIG. 11 is a circuit diagram illustrating a configuration example of a rectifier circuit according to an embodiment; and

FIG. 12 is a circuit diagram illustrating a configuration example of a rectifier circuit according to another embodiment.

### DETAILED DESCRIPTION

Hereinafter, one or embodiments of the present disclosure will be described in further detail including with reference to the drawings.

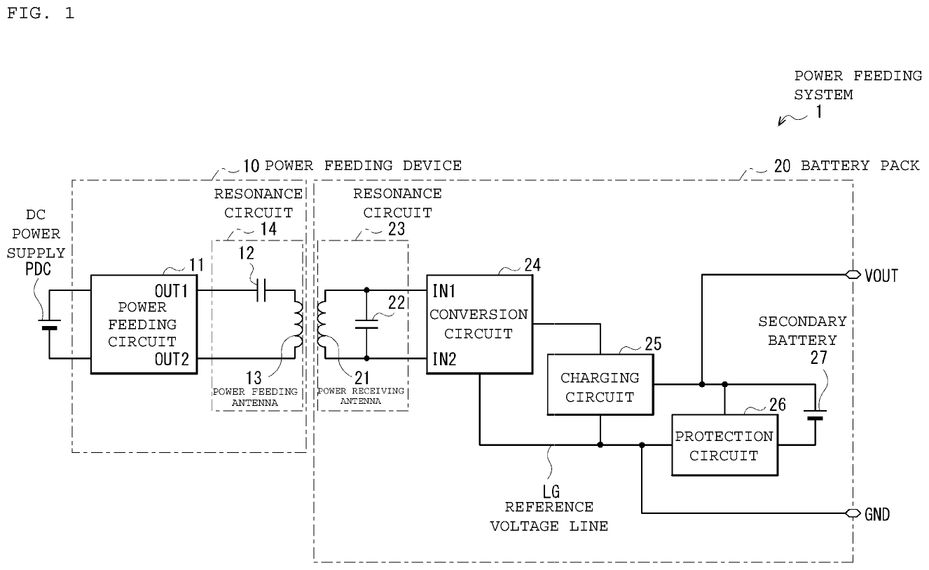

FIG. 1 illustrates a configuration example of a power feeding system 1 including a power receiving circuit according to an embodiment. The power feeding system 1 is a power feeding system by a magnetic field resonance method, and is configured to wirelessly supply power to a secondary battery and charge the secondary battery. The power feeding system 1 includes a power feeding device 10 and a battery pack 20.

The power feeding device 10 is configured to generate AC power based on power supplied from a DC power supply PDC, and supply the generated AC power to the battery pack 20. The power feeding device 10 includes a power feeding circuit 11, a capacitor 12, and a power feeding antenna 13.

The power feeding circuit 11 is configured to generate AC power based on power supplied from the DC power supply PDC. The frequency of the AC power is set to a predetermined frequency fsig. The value of the frequency fsig is set to the same value as the resonance frequency for of a resonance circuit 14 (described later) in the power feeding device 10 and the resonance frequency for of a resonance circuit 23 (described later) in the battery pack 20 described later. The power feeding circuit 11 outputs the generated AC power as the power between the terminals: output terminals OUT1 and OUT2.

One end of the capacitor 12 is connected to the output terminal OUT1 of the power feeding circuit 11, and the other end is connected to one end of the power feeding antenna 13. The capacitor 12 constitutes a resonance circuit 14 together with the power feeding antenna 13. The value of the resonance frequency for of the resonance circuit 14 is set to the same value as the frequency fsig of the AC power generated by the power feeding circuit 11 and the resonance frequency for of a resonance circuit 23 (described later) in the battery pack 20.

The power feeding antenna 13 is configured to generate an electromagnetic field based on supplied power. One end of the power feeding antenna 13 is connected to the other end of the capacitor 12, and the other end is connected to the output terminal OUT2 of the power feeding circuit 11. The power feeding antenna 13 constitutes a resonance circuit 14 together with the capacitor 12.

The battery pack 20 is configured to generate DC power based on AC power wirelessly supplied from the power feeding device 10, and perform a charging operation based on the DC power. The battery pack 20 includes a power receiving antenna 21, a capacitor 22, a conversion circuit 24, a charging circuit 25, a protection circuit 26, a secondary battery 27, and terminals VOUT and GND.

The power receiving antenna 21 is configured to generate AC power based on an electromagnetic field generated by the power feeding antenna 13. One end of the power receiving antenna 21 is connected to one end of the capacitor 22 and an input terminal IN1 of the conversion circuit 24, and the other end is connected to the other end of the capacitor 22 and an input terminal IN2 of the conversion circuit 24. The power receiving antenna 21 constitutes a resonance circuit 23 together with the capacitor 22. The value of the resonance frequency for of the resonance circuit 23 is set to the same value as the frequency fsig of AC power generated by the power feeding circuit 11 and the resonance frequency for of the resonance circuit 14.

One end of the capacitor 22 is connected to one end of the power receiving antenna 21 and the input terminal IN1 of the conversion circuit 24, and the other end is connected to the other end of the power receiving antenna 21 and the input terminal IN2 of the conversion circuit 24. The capacitor 22 constitutes the resonance circuit 23 together with the power receiving antenna 21.

With this configuration, in the power feeding system 1, power can be wirelessly supplied from the power feeding device 10 to the battery pack 20 by a magnetic field resonance method.

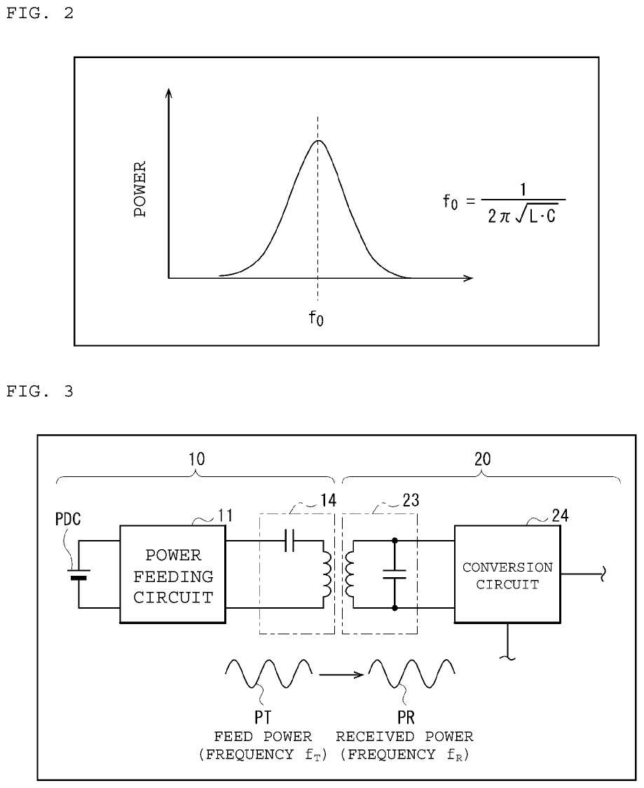

FIG. 2 illustrates an example of the resonance frequency characteristics of a resonance circuit. As illustrated in FIG. 2, the resonance frequency f₀ is determined by the inductance L and the capacitance C. Specifically, the resonance frequency for of the resonance circuit 14 is determined by, for example, the inductance L of the power feeding antenna 13 and the capacitance C of the capacitor 12. Note that the resonance frequency for can actually change depending on the mutual inductance M between the power feeding antenna 13 and the power receiving antenna 21, or the like. Similarly, the resonance frequency for of the resonance circuit 23 is determined by, for example, the inductance L of the power receiving antenna 21 and the capacitance C of the capacitor 22. Note that the resonance frequency for can actually change depending on the mutual inductance M between the power feeding antenna 13 and the power receiving antenna 21, or the like. The resonance circuit resonates at the resonance frequency fo, and the amplitude of AC power increases.

FIG. 3 illustrates an example of wireless power supply by a magnetic field resonance method. The power feeding device 10 supplies feed power PT, which is an AC power, to the battery pack 20. The frequency f_{T} of the feed power PT and the resonance frequency for of the resonance circuit 14 are set to coincide with each other. The battery pack 20 receives AC power supplied from the power feeding device 10 as received power PR. The frequency f_{R} of the received power PR is the same as the frequency f_{T} of the feed power PT, and is set to coincide with the resonance frequency f_{DR} of the resonance circuit 23.

As described above, in wireless power feeding by a magnetic field resonance method, the frequency fsig of AC power generated by the power feeding circuit 11, the resonance frequency f_{0T} of the resonance circuit 14, and the resonance frequency f_{0R} of the resonance circuit 23 coincide with each other, so that wireless power feeding can be efficiently performed.

In the power feeding system 1, the capacitor 22 in the battery pack 20 is configured such that the capacitance C changes depending on the temperature.

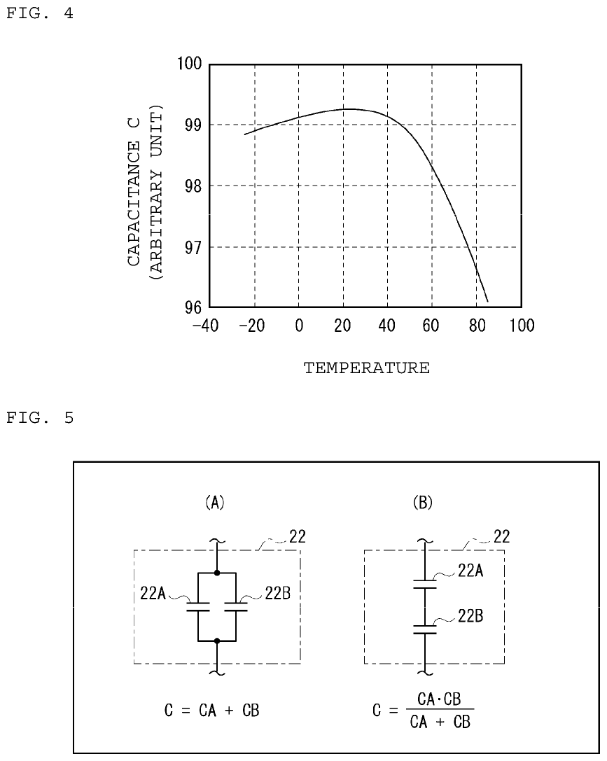

FIG. 4 illustrates an example of the temperature characteristic of the capacitance C in the capacitor 22. The capacitance C in the capacitor 22 changes depending on the temperature. In this example, the slope is almost zero around room temperature, and when the temperature rises from room temperature, the capacitance C decreases depending on the temperature. Such a temperature characteristic has a characteristic also called B characteristic. As described later, the capacitor 22 is thermally connected to the conversion circuit 24. Therefore, for example, when the conversion circuit 24 generates heat, the heat generated in the conversion circuit 24 is conducted to the capacitor 22, and the capacitance C in the capacitor 22 decreases in this example.

The capacitor 22 may be configured using one capacitor or may be configured using a plurality of capacitors.

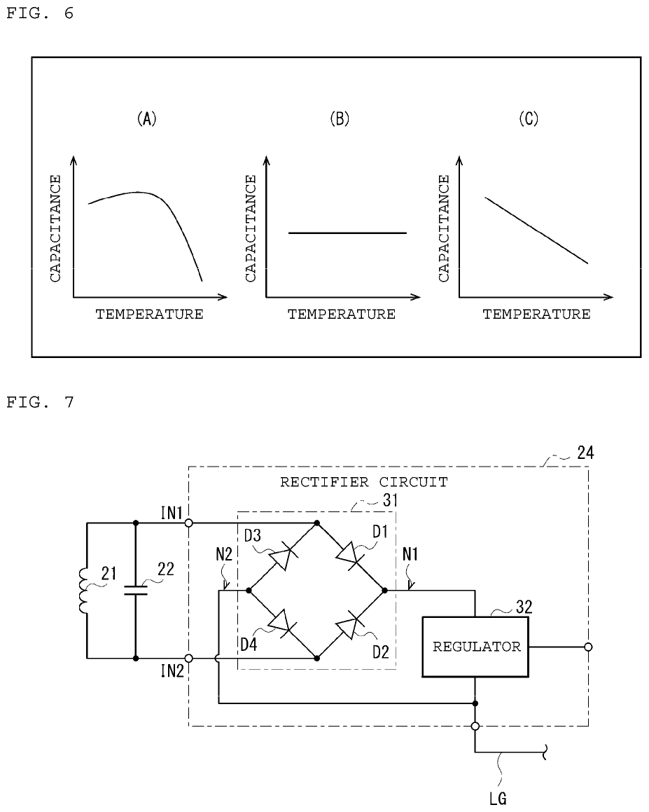

FIG. 5 illustrates an example of a case where the capacitor 22 is configured using two capacitors 22A and 22B, where (A) illustrates a case where the two capacitors 22A and 22B are connected in parallel, and (B) illustrates a case where the two capacitors 22A and 22B are connected in series.

In a case where the two capacitors 22A and 22B are connected in parallel (a part (A) of FIG. 5), the capacitance C of the capacitor 22 is expressed by the following formula using the capacitances CA and CB of the two capacitors 22A and 22B.

C=CA+CB

In addition, in a case where the two capacitors 22A and 22B are connected in series (a part (B) of FIG. 5), the capacitance C of the capacitor 22 is expressed by the following formula using the capacitances CA and CB of the two capacitors 22A and 22B.

C=CA·CB/(CA+CB)

Some capacitors have various temperature characteristics. Therefore, the capacitor 22 can be configured using the two capacitors 22A and 22B having temperature characteristics different from each other.

FIG. 6 illustrates an example of the temperature characteristic of a capacitor, where (A) illustrates the so-called B characteristic, (B) illustrates the so-called CH characteristic, and (C) illustrates the so-called SL characteristic. For example, in the B characteristic (a part (A) of FIG. 6), the slope is almost zero around room temperature, and when the temperature rises from room temperature, the capacitance decreases depending on the temperature. For example, in the CH characteristic (a part (B) of FIG. 6), the capacitance is kept substantially constant over a wide temperature range. For example, in the SL characteristic (a part (C) of FIG. 6), the capacitance decreases approximately in a linear function as the temperature increases.

By using the two capacitors 22A and 22B having temperature characteristics different from each other, it is possible to realize the capacitor 22 having temperature characteristics in which the temperature characteristics of the two capacitors 22A and 22B are mixed. As a result, the degree of freedom in setting the temperature characteristic of the capacitor 22 can be increased. In this example, the two capacitors 22A and 22B are connected, but the present disclosure is not limited thereto, and three or more capacitors may be connected. In addition, the connection is not limited to the series connection or the parallel connection, and more complicated connection in which the series connection and the parallel connection are combined may be performed using more capacitors, for example. As a result, for example, the degree of freedom in setting the temperature characteristic of the capacitor 22 can be further increased.

The conversion circuit 24 (FIG. 1) is configured to convert AC power generated by the power receiving antenna 21 into DC power.

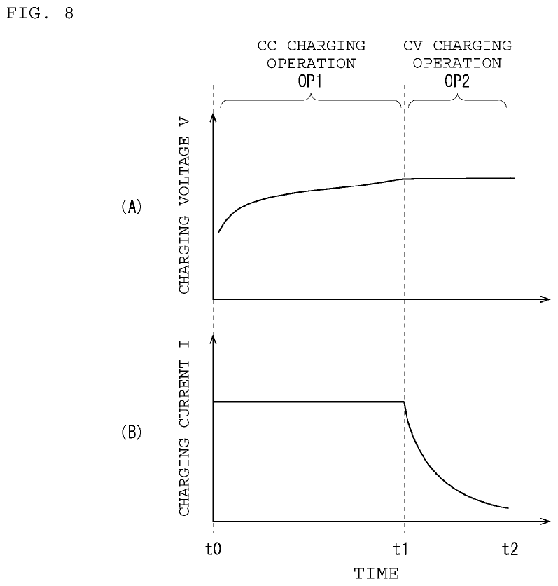

FIG. 7 illustrates a configuration example of the conversion circuit 24. The conversion circuit 24 includes a rectifier circuit 31 and a regulator 32.

The rectifier circuit 31 is configured to perform a rectifying operation based on AC power generated by the power receiving antenna 21. The rectifier circuit 31 includes diodes D1 to D4. The anode of the diode D1 is connected to the input terminal IN1 of the conversion circuit 24, and the cathode is connected to a node N1. The anode of the diode D2 is connected to the input terminal IN2 of the conversion circuit 24, and the cathode is connected to the node N1. The anode of the diode D3 is connected to a node N2, which is led to a reference voltage line LG, and the cathode is connected to the input terminal IN1. The anode of the diode D4 is connected to the node N2, and the cathode is connected to the input terminal IN1. The diodes D1 to D4 constitute a bridge diode that performs full-wave rectification. With this configuration, the rectifier circuit 31 outputs the rectified voltage as the voltage between the nodes: the node N1 and the node N2.

The regulator 32 is configured to generate DC power based on power rectified by the rectifier circuit 31. The regulator 32 operates based on the voltage between the nodes: the node N1 and the node N2. As the regulator 32, for example, a low dropout (LDO) linear regulator can be used.

With this configuration, the conversion circuit 24 converts AC power generated by the power receiving antenna 21 into DC power.

The charging circuit 25 (FIG. 1) is configured to perform a charging operation of charging the secondary battery 27 based on DC power supplied from the conversion circuit 24.

FIG. 8 illustrates an operation example of the charging operation by the charging circuit 25, where (A) illustrates a waveform of the voltage (charging voltage V) between the anode and the cathode in the secondary battery 27, and (B) illustrates a waveform of current (charging current I) flowing from the anode to the cathode in the secondary battery 27.

When charging the secondary battery 27, the charging circuit 25 first performs a CC (Constant Current) charging operation OP1 in the period from timing t0 to t1. In the CC charging operation OP1, the charging circuit 25 charges the secondary battery 27 while controlling the charging current I to be constant. As the secondary battery 27 is charged, the charging voltage V gradually increases. Then, for example, at the timing t1, when the charging voltage V reaches a predetermined voltage level, the charging circuit 25 performs a constant voltage (CV) charging operation OP2. In the CV charging operation OP2, the charging circuit 25 charges the secondary battery 27 while controlling the charging voltage V to be constant. As the secondary battery 27 is charged, the charging current I decreases. Then, in this example, at the timing t2, the charging circuit 25 finishes charging the secondary battery 27.

In this manner, the charging circuit 25 charges the secondary battery 27 by performing the CC charging operation OP1 and the CV charging operation OP2 in this order.

The protection circuit 26 is configured to perform a protection operation of protecting the secondary battery 27 by monitoring the voltage between the anode and the cathode in the secondary battery 27 and current flowing through the secondary battery 27. Specifically, the protection circuit 26 monitors the secondary battery 27 to protect the secondary battery 27 so that the operating state of the secondary battery 27 does not become an overcharge state or an overdischarge state, for example. In addition, the protection circuit 26 is configured to protect the secondary battery 27 so that an overcurrent does not flow through the secondary battery 27, for example, by monitoring current flowing in the protection circuit 26.

The secondary battery 27 is configured to store power. In this example, the secondary battery 27 is a coin-type lithium ion secondary battery. In this example, the secondary battery 27 includes one secondary battery cell. The anode of the secondary battery 27 is connected to the charging circuit 25 and connected to the terminal VOUT, and the cathode is connected to the reference voltage line LG via the protection circuit 26.

The terminals VOUT and GND are output terminals to supply power stored in the battery pack 20 to a load circuit (not illustrated). The terminal VOUT is connected to the anode of the secondary battery 27. The terminal GND is connected to the reference voltage line LG.

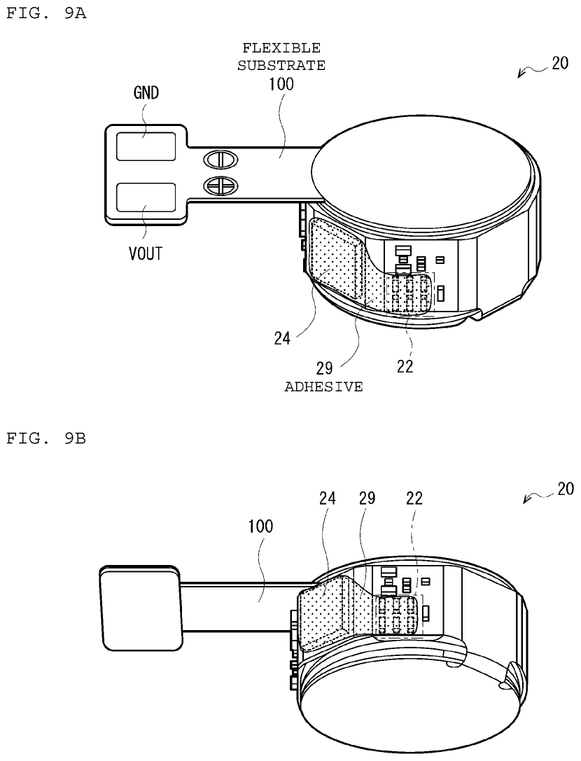

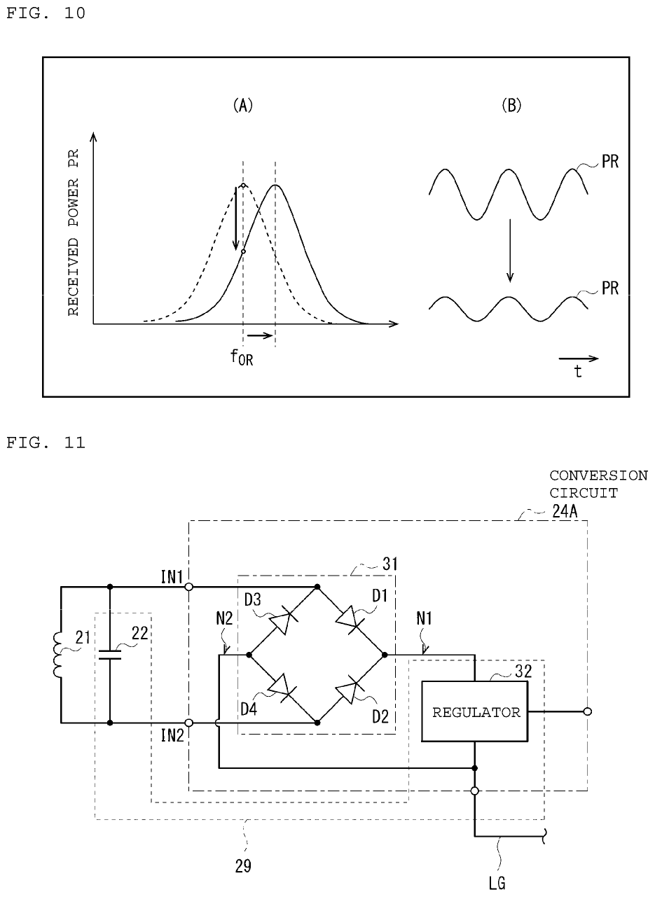

FIGS. 9A and 9B illustrate an example of an external configuration of the battery pack 20. In this example, the battery pack 20 is configured by enclosing a coin-type secondary battery 27 using a flexible substrate 100 on which various elements in the battery pack 20 are mounted (FPC: Flexible printed circuits). In this example, the conversion circuit 24 includes one semiconductor chip and is packaged. In this example, the capacitor 22 includes six chip capacitors. The conversion circuit 24 and the six chip capacitors are provided at adjacent positions. The conversion circuit 24 and the six chip capacitors are covered with an adhesive 29. The adhesive 29 includes a resin having thermal conductivity. As a result, the conversion circuit 24 is thermally connected to the six chip capacitors in the capacitor 22. As a result, in the battery pack 20, heat generated by the conversion circuit 24 is more efficiently conducted to the six chip capacitors.

With this configuration, in the battery pack 20, the secondary battery 27 is charged based on power supplied from the power feeding device 10. The secondary battery 27 is first charged by the CC charging operation OP1, and then charged by the CV charging operation OP2. Since the charging current I decreases in the CV charging operation OP2, the charging power, which is the product of the charging voltage V and the charging current I, decreases. As described above, in the battery pack 20, since the charging power decreases, the power supplied from the power feeding device 10 and the charging power cannot be balanced, the power consumption in the conversion circuit 24 increases, and the conversion circuit 24 generates heat. The heat generated by the conversion circuit 24 is efficiently conducted to the capacitor 22, the capacitance C in the capacitor 22 decreases due to the increase in temperature, and the resonance frequency for of the resonance circuit 23 increases. As a result, the value of the resonance frequency for deviates from the frequency fsig of AC power generated by the power feeding circuit 11 or the value of the resonance frequency for of the resonance circuit 14. As a result, in the power feeding system 1, the power feeding efficiency from the power feeding device 10 to the battery pack 20 is reduced, and the power received by the battery pack 20 from the power feeding device 10 can be reduced, so that heat generation in the battery pack 20 can be effectively suppressed.

Here, the power receiving antenna 21 corresponds to a specific example of the “power receiving antenna” in an embodiment of the present disclosure. The capacitor 22 corresponds to a specific example of the “capacitor portion” in an embodiment of the present disclosure. The conversion circuit 24 corresponds to a specific example of the “conversion circuit” in an embodiment of the present disclosure. The adhesive 29 corresponds to a specific example of the “heat conducting member” in an embodiment of the present disclosure.

Next, the operation and effect of the power feeding system 1 of the present embodiment will be described.

First, the overall operation outline of the power feeding system 1 will be described with reference to FIG. 1. The power feeding circuit 11 of the power feeding device 10 generates AC power based on power supplied from the DC power supply PDC. The resonance circuit 14 causes the AC power to resonate at the resonance frequency for. The power feeding antenna 13 generates an electromagnetic field based on supplied power. The power receiving antenna 21 of the battery pack 20 generates AC power based on the electromagnetic field generated by the power feeding antenna 13. The resonance circuit 23 causes the AC power to resonate at the resonance frequency for. The conversion circuit 24 converts AC power generated by the power receiving antenna 21 into DC power. The charging circuit 25 performs a charging operation of charging the secondary battery 27 based on DC power supplied from the conversion circuit 24. The protection circuit 26 performs a protection operation of protecting the secondary battery 27 by monitoring the voltage between the anode and the cathode in the secondary battery 27 and current flowing through the secondary battery 27. The secondary battery 27 stores power.

In the battery pack 20, as illustrated in FIG. 8, the charging circuit 25 first performs the CC charging operation OP1, and then performs the CV charging operation OP2. Since the charging current I decreases in the CV charging operation OP2, the charging power, which is the product of the charging voltage V and the charging current I, decreases. As described above, in the battery pack 20, since the charging power decreases, the power supplied from the power feeding device 10 and the charging power cannot be balanced, the power consumption in the conversion circuit 24 increases, and the conversion circuit 24 generates heat.

In the battery pack 20, the conversion circuit 24 and the capacitor 22 are thermally connected through the adhesive 29 having thermal conductivity. Therefore, the heat generated by the conversion circuit 24 is more efficiently conducted to the capacitor 22. As a result, the temperature of the capacitor 22 rises.

As illustrated in FIG. 4, when the temperature rises from room temperature, the capacitance C of the capacitor 22 decreases depending on the temperature. When the capacitance C in the capacitor 22 decreases, the resonance frequency for of the resonance circuit 23 increases.

FIG. 10 schematically illustrates the received power PR, where (A) illustrates a resonance frequency characteristic in the resonance circuit 23, and (B) illustrates a waveform of the received power PR. As described above, when the capacitance C of the capacitor 22 decreases, the resonance frequency f_{0R} of the resonance circuit 23 increases. The frequency f_{R} of the received power PR is the same as the frequency f_{T} of the feed power PT of the power feeding device 10 and does not change. Therefore, as illustrated in a part (A) of FIG. 10, the received power PR decreases by the deviation of the resonance frequency f_{0R} of the resonance circuit 23. Specifically, as illustrated in a part (B) of FIG. 10, the amplitude of the received power PR decreases.

When the received power PR decreases as described above, in the battery pack 20, the balance between the power supplied from the power feeding device 10 and the charging power is improved, the power consumption in the conversion circuit 24 decreases, and the calorific value in the conversion circuit 24 decreases. In this way, the battery pack 20 can effectively suppress heat generation.

As described above, the battery pack 20 includes: the power receiving antenna 21 capable of receiving AC power supplied from the power feeding antenna 13 by a magnetic field resonance method; the capacitor 22 that is connected to the power receiving antenna 21, has a capacitance changeable with temperature, and constitutes a resonance circuit together with the power receiving antenna 21; the conversion circuit 24 capable of converting the AC power into DC power; and the adhesive 29 capable of conducting heat from the conversion circuit 24 to the capacitor 22. As a result, in the battery pack 20, when the conversion circuit 24 generates heat, the heat generated by the conversion circuit 24 is efficiently conducted to the capacitor 22, the resonance frequency for of the resonance circuit 23 including the capacitor 22 changes, and the power feeding efficiency from the power feeding device 10 to the battery pack 20 decreases. As a result, the battery pack 20 can effectively suppress heat generation.

That is, for example, as in the technique described in Japanese Patent Application Laid-Open No. 2014-82864, when excessive power is supplied from the power feeding device, the power receiving device instructs the power feeding device to reduce the power. In this case, the circuit configuration becomes complicated, and the operation also becomes complicated. On the other hand, in the battery pack 20 according to the present embodiment, it is only necessary to thermally connect the capacitor 22 having temperature characteristics and the conversion circuit 24, so that the circuit configuration and operation can be simplified. As a result, the battery pack 20 can effectively suppress heat generation with a simple circuit configuration and operation.

In the battery pack 20, since the adhesive 29, which is a resin member having thermal conductivity, covers the conversion circuit 24 and the capacitor 22, heat generated by the conversion circuit 24 can be efficiently conducted to the capacitor 22. In particular, by using the adhesive 29, the number of members can be reduced as compared with the case of using, for example, a heat pipe, and the conversion circuit 24 and the capacitor 22 can be thermally coupled more easily. As a result, the sensitivity to temperature in the conversion circuit 24 can be enhanced, and the capacitance C of the capacitor 22 can be changed with high sensitivity based on the temperature. As a result, the battery pack 20 can effectively suppress heat generation.

In the battery pack 20, as illustrated in FIGS. 9A and 9B, the conversion circuit 24 and the capacitor 22 are provided at positions adjacent to each other. As a result, the sensitivity to temperature in the conversion circuit 24 can be enhanced, and the capacitance C of the capacitor 22 can be changed with high sensitivity based on the temperature. As a result, the battery pack 20 can effectively suppress heat generation.

As described above, the present embodiment includes: the power receiving antenna capable of receiving AC power supplied from the power feeding antenna by a magnetic field resonance method; the capacitor that is connected to the power receiving antenna, has a capacitance changeable with temperature, and constitutes a resonance circuit together with the power receiving antenna; the conversion circuit capable of converting the AC power into DC power; and the adhesive capable of conducting heat from the conversion circuit to the capacitor, thereby effectively suppressing heat generation.

The present embodiment includes the adhesive that is a resin member having thermal conductivity covers the conversion circuit and the capacitor, thereby effectively suppressing heat generation.

The present embodiment includes the conversion circuit and the capacitor provided at positions adjacent to each other, thereby effectively suppressing heat generation.

As illustrated in FIG. 4, the capacitance C of the capacitor 22 decreases in accordance with the temperature when the temperature rises from room temperature. However, the present disclosure is not limited thereto. Alternatively, for example, the capacitance C of the capacitor 22 may rise according to the temperature when the temperature rises from room temperature. In this case, when the temperature increases, the resonance frequency for of the resonance circuit 23 deviates from the resonance frequency for of the resonance circuit 14, and the power feeding efficiency decreases, so that heat generation in the battery pack 20 can be effectively suppressed.

In an embodiment, the present technology is applied to a coin-type secondary battery, but the present technology is not limited thereto. For example, the present technology may be applied to a larger secondary battery. In this case, unlike the case of the above embodiment (FIGS. 9A and 9B), the degree of freedom of arranging each element in the battery pack 20 is increased. However, in this case, heat generated by the conversion circuit 24 can be efficiently conducted to the capacitor 22 by arranging the conversion circuit 24 and the capacitor 22 at positions adjacent to each other. As a result, the sensitivity to temperature in the conversion circuit 24 can be enhanced, and the capacitance C of the capacitor 22 can be changed with high sensitivity based on the temperature.

In an embodiment, the present technology is applied to a lithium ion secondary battery, but the present technology is not limited thereto. For example, the present technology may be applied to a nickel-hydrogen secondary battery or the like. In this case, the protection circuit 26 may not be provided.

In an embodiment, as illustrated in FIGS. 9A and 9B, the conversion circuit 24 is configured by one semiconductor chip, but the present technology is not limited thereto. Alternatively, the conversion circuit 24 may be configured by separate components. In this case, the component that generates heat most easily among the components constituting the conversion circuit 24 and the capacitor 22 can be thermally connected. Hereinafter, the present modification will be described in detail with some examples.

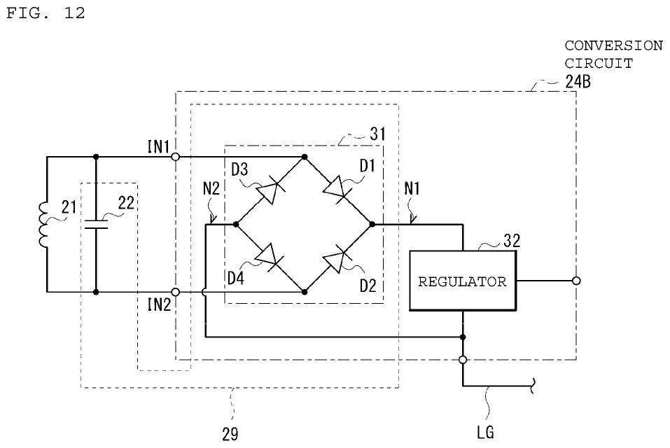

FIG. 11 illustrates a configuration example of a conversion circuit 24A according to the present modification. The conversion circuit 24A includes a rectifier circuit 31 and a regulator 32. In this example, each of the rectifier circuit 31 and the regulator 32 is a separate component. In this example, the regulator 32 can generate the most heat among the components constituting the conversion circuit 24A. Specifically, when the conversion circuit 24A generates heat by the charging circuit 25 performing the CV charging operation OP2, the regulator 32 can generate heat most. Therefore, in this example, the regulator 32 and the capacitor 22 are provided at positions adjacent to each other and covered with an adhesive 29. Accordingly, the regulator 32 is thermally connected to the capacitor 22. As a result, in the battery pack 20 according to the present modification, heat generated by the regulator 32 is efficiently conducted to the capacitor 22.

FIG. 12 illustrates a configuration example of another conversion circuit 24B according to the present modification. The conversion circuit 24B includes a rectifier circuit 31 and a regulator 32. Each of the rectifier circuit 31 and the regulator 32 is a separate component. In this example, the rectifier circuit 31 can generate the most heat among the components constituting the conversion circuit 24B. Specifically, when the conversion circuit 24B generates heat by the charging circuit 25 performing the CV charging operation OP2, the temperature of the rectifier circuit 31 can generate heat most. Therefore, in this example, the rectifier circuit 31 and the capacitor 22 are provided at positions adjacent to each other and covered with an adhesive 29. Accordingly, the rectifier circuit 31 is thermally connected to the capacitor 22. As a result, in the battery pack 20 according to the present modification, heat generated by the rectifier circuit 31 is efficiently conducted to the capacitor 22.

The component that can generate the most heat can actually be confirmed by measuring the temperature of each component. Specifically, for example, in a period in which the power feeding device 10 is supplying power to the battery pack 20, the temperature of the rectifier circuit 31 and the temperature of the regulator 32 in the battery pack 20 change, for example. As illustrated in FIG. 8, since the charging circuit 25 performs the CC charging operation OP1 and the CV charging operation OP2, the temperature of the rectifier circuit 31 and the temperature of the regulator 32 change as the secondary battery 27 is charged. For example, the temperature of the components can be highest in a period in which the charging circuit 25 performs the CV charging operation OP2. In such a series of power supply operations, for example, the component having the highest temperature is the component that can generate the most heat.

In an embodiment, the conversion circuit 24 is configured using the rectifier circuit 31 and the regulator 32, but the present disclosure is not limited thereto. For example, the conversion circuit may be configured using the rectifier circuit 31 and a DC/DC converter, or the conversion circuit may be configured using an AC/DC converter.

In an embodiment, the conversion circuit 24 and the capacitor 22 are thermally connected using the adhesive 29 including a resin having thermal conductivity, but the present disclosure is not limited thereto. Alternatively, for example, a heat pipe may be used to thermally connect the conversion circuit 24 and the capacitor 22.

Two or more of these modifications may be combined.

Although the present technology has been described with reference to one or more embodiments, the present technology is not limited thereto, and various modifications can be made.

For example, the resonance circuits 14 and 23 having the circuit configuration illustrated in FIG. 1 are used, but the present technology is not limited thereto, and any circuit configuration may be used as long as it is a resonance circuit.

Since the effects described in the present specification are merely examples, the effects of the present disclosure are not limited to the effects described in the present specification. Thus, other effects regarding the present disclosure may be obtained.

The present disclosure includes the following aspects according to an embodiment.

<1>

A power receiving circuit including:
a power receiving antenna capable of receiving AC power supplied from a power feeding antenna by a magnetic field resonance method;
a capacitor portion that is connected to the power receiving antenna, includes a first capacitor whose capacitance is changeable with temperature, and constitutes a resonance circuit together with the power receiving antenna;
a conversion circuit capable of converting the AC power into DC power; and
a heat conducting member capable of conducting heat from the conversion circuit to the first capacitor.
   <2>

The power receiving circuit according to <1>, wherein
the conversion circuit includes a heating unit,
the heat conducting member is capable of thermally connecting the heating unit with the first capacitor, and
the heating unit is a component that may generate heat most among components constituting the conversion circuit.
   <3>

The power receiving circuit according to <2>, wherein
the conversion circuit includes:
a rectifier circuit capable of rectifying the AC power supplied from the power receiving antenna; and
a regulator capable of generating the DC power based on an output signal of the rectifier circuit, and
the heating unit includes the rectifier circuit or the regulator.
   <4>

The power receiving circuit according to <2> or <3>, wherein
the heat conducting member is a resin member having thermal conductivity and covering the heating unit and the first capacitor.
   <5>

The power receiving circuit according to any one of <2> to <4>, wherein
the heating unit and the first capacitor are provided at positions adjacent to each other.
   <6>

The power receiving circuit according to <1>, wherein
the heat conducting member is a resin member having thermal conductivity and covering the conversion circuit and the first capacitor.
   <7>

The power receiving circuit according to <1> or <2>, wherein
the conversion circuit and the first capacitor are provided at positions adjacent to each other.
   <8>

The power receiving circuit according to any one of <1> to <7>, wherein
the capacitance of the first capacitor decreases at temperatures equal to or higher than a predetermined temperature.
   <9>

The power receiving circuit according to any one of <1> to <8>, wherein
the capacitor portion further includes a second capacitor having a temperature characteristic of capacitance different from a temperature characteristic of capacitance of the first capacitor, and
the first capacitor and the second capacitor are connected to each other in series or in parallel.
   <10>

A battery pack including:
the power receiving circuit according to any one of <1> to <9>;
a secondary battery; and
a charging circuit capable of charging the secondary battery based on the DC power supplied from the conversion circuit of the power receiving circuit.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A power receiving circuit comprising:
a power receiving antenna capable of receiving AC power supplied from a power feeding antenna by a magnetic field resonance method;
a capacitor portion that is connected to the power receiving antenna, includes a first capacitor whose capacitance is changeable with temperature, and constitutes a resonance circuit together with the power receiving antenna;
a conversion circuit capable of converting the AC power into DC power; and
a heat conducting member capable of conducting heat from the conversion circuit to the first capacitor.

2. The power receiving circuit according to claim 1, wherein
the conversion circuit includes a heating unit
the heat conducting member is capable of thermally connecting the heating unit with the first capacitor, and
the heating unit is a component that may generate heat most among components constituting the conversion circuit.

3. The power receiving circuit according to claim 2, wherein
the conversion circuit includes:
a rectifier circuit capable of rectifying the AC power supplied from the power receiving antenna; and
a regulator capable of generating the DC power based on an output signal of the rectifier circuit, and
the heating unit includes the rectifier circuit or the regulator.

4. The power receiving circuit according to claim 2, wherein
the heat conducting member is a resin member having thermal conductivity and covering the heating unit and the first capacitor.

5. The power receiving circuit according to claim 2, wherein
the heating unit and the first capacitor are provided at positions adjacent to each other.

6. The power receiving circuit according to claim 1, wherein
the heat conducting member is a resin member having thermal conductivity and covering the conversion circuit and the first capacitor.

7. The power receiving circuit according to claim 1, wherein
the conversion circuit and the first capacitor are provided at positions adjacent to each other.

8. The power receiving circuit according to claim 1, wherein
the capacitance of the first capacitor decreases at temperatures equal to or higher than a predetermined temperature.

9. The power receiving circuit according to claim 1, wherein
the capacitor portion further includes a second capacitor having a temperature characteristic of capacitance different from a temperature characteristic of capacitance of the first capacitor, and
the first capacitor and the second capacitor are connected to each other in series or in parallel.

10. A battery pack comprising:
the power receiving circuit according to claim 1;
a secondary battery; and
a charging circuit capable of charging the secondary battery based on the DC power supplied from the conversion circuit of the power receiving circuit.
